(19) United States
(12) Patent Application Publication
(10) Pub. No.: US 2003/0084182 A1
(43) Pub. Date: May 1, 2003

(54) Method of transmitting packets via a telecommunications network using IP protocol

(75) Inventors: Patrice Mahiddini, Colombes (FR); Isabelle Rose, Rueil Malmaison (FR)

Correspondence Address: SUGHRUE MION, PLLC, Suite 800, 2100 Pennsylvania Avenue, N.W., Washington, DC, 20037-3213, US

(73) Assignee: ALCATEL

(21) Appl. No.: 10/277,897

(22) Filed: Oct. 23, 2002

(30) Foreign Application Priority Data
Oct. 25, 2001 (FR) 01 13 802

(51) Int. Cl. G06F 15/16

(52) U.S. Cl. 709/233

(57) ABSTRACT

The invention relates to a method of receiving packets via a telecommunications network using IP protocol. The method consists in analyzing at least the first incoming packet, in calculating the bandwidth and/or bit rate needed on the basis of the result of the analysis, and in adjusting the reception bandwidth or bit rate as a function of the result of the calculation. If the receiver relies on TCP protocol, the bandwidth or bit rate is adjusted by setting the received packet acknowledgment duration (t).

The invention relates to a method of transmitting data in a telecommunications network using Internet protocol (IP). The invention also relates to a terminal and to apparatus for managing bandwidth making use of the method.

### BACKGROUND OF THE INVENTION

An Internet type telecommunications network is made up of a variety of portions that are non-uniform, in particular having data rates that can vary over a wide range from one portion of the network to another. This diversity, and also its simplicity, are major reasons for the success of the network.

Unfortunately, diversity and simplicity give rise to troublesome drawbacks. In particular, transport protocols, such as the transport control protocol (TCP) are such that if a user, i.e. a client application, downloads data from a server, then the data being downloaded will tend to occupy the maximum authorized bandwidth on the communications channel, with this transmission then taking place to the detriment of other users.

To remedy that drawback, proposals have already been made to give packets transmitted over the Internet bits that specify a priority. However, determining priority in packet routing implies the existence of effective control or regulation members that do not exist in that network, unlike other networks such as those operating in asynchronous transfer mode (ATM) in which each packet is given greater or lesser priority. In an ATM network it is known that each data packet that is transmitted is certain to reach its destination with a quality of service (QOS) that is guaranteed, i.e. that certain packets, packets having the greatest priority, are certain to arrive at their destination in a guaranteed length of time and at an error rate below a determined limit and also at a bit rate that is guaranteed, whereas other packets of an immediately lower priority rank are also conveyed in real time but without the bit rate being guaranteed; other data of lower priority is not transmitted in real time.

### OBJECTS AND SUMMARY OF THE INVENTION

An object of the present invention is thus to provide quality of service in an Internet type network but without using the complex control means of an ATM network.

To this end, the invention provides a method of managing a network in which, in a terminal, at least the first packet of an incoming file is analyzed, and on the basis of that analysis, the necessary bit rate or the maximum delay between successive packets is calculated and the reception bit rate or passband is adjusted as a function of the result of the calculation. In one embodiment, the terminal sends the bit rate or delay information to a network node so that the transfer of files takes place at the requested bit rate or with a delay that is substantially equal to the delay requested.

For example, if the terminal uses the TCP protocol, the bit rate, i.e. the transmission speed, is set by the speed of acknowledgment, i.e. the time between receiving a packet and sending an acknowledge signal, and this speed of acknowledgment is determined in the terminal. It is known that in the TCP protocol, it is the reception of an acknowledge signal by a sender that triggers the sending of following packets to the terminal.

When using user datagram protocol (UDP) without acknowledgment, rate-setting is performed by increasing or decreasing the time between packets.

Thus, to set the data rate in an Internet transmission, and thus avoid saturating the link (so as to allow for coexistence with other transmissions), there is no need to provide a special format for the data that is to be transmitted. It suffices to provide simple analysis means in the terminal and, possibly, in the network node.

In the network node, it is possible to use active rather than passive means for allocating resources enabling the bandwidth needed by each terminal to be allocated thereto.

It should also be observed that, unusually, the invention combines two distinct layers of the Internet technique, namely firstly the TCP or UDP transport layer constituted by a protocol that does not recognize data, and secondly the application layer such as hypertext transfer protocol (HTTP) which recognizes data and can give or extract data rate information; for example, with data of the joint photographic experts group (JPEG) type or of the motor picture experts group (MPEG) type, data rate information is to be found in a well-determined location.

Thus, the invention provides a method of receiving packets via a telecommunications network using IP protocol, the method being characterized in that at least the content and the content type of the first incoming packet is analyzed, the bandwidth and/or bit rate required is calculated on the basis of the result of this analysis, and the reception bandwidth or bit rate is adjusted as a function of the result of the calculation.

In an embodiment, the receiver makes use of TCP protocol and the bandwidth or the bit rate is adjusted by setting the time taken to acknowledge received packets.

In another embodiment, the receiver uses UDP protocol and the bandwidth or the bit rate is adjusted by setting the time between receiving two successive packets.

The requested bandwidth is preferably granted only if it does not exceed a predetermined limit.

The allocated bandwidth can be made to depend on bandwidth requests coming from other users.

In an example, the bandwidth allocated to a receiver is made to depend both on the uses or bandwidth requests from other users and also on the bandwidth requirements forecast for future requests from such other users.

Bandwidth allocation can be performed from the network node to which the user is connected.

The invention also provides a telecommunications terminal for receiving, on request, packets using the IP protocol via an Internet type network, the terminal being characterized in that it has means for analyzing the content and the content type of at least the first-received packet in order to determine the bandwidth or the bit rate needed to receive the requested packets, and means for adapting the reception bandwidth or bit rate to the results provided by the analysis means.

In an example, the terminal uses a TCP type protocol in which, after receiving a packet or a set of packets, the receiver sends an acknowledgment to the sender so that the sender continues to send, and the means for adapting bandwidth or bit rate comprise means for varying acknowledgment duration, i.e. the time that elapses between reception and sending an acknowledgment of said reception.

In another embodiment, the packets are received using a UDP type protocol without acknowledgment being sent to the sender, and the means for adjusting the bandwidth or the bit rate comprise means for controlling the spacing between received packets.

The terminal may have means for limiting the bandwidth that is requested.

The terminal may also have means for receiving bandwidth authorization after sending a request.

The invention also provides apparatus for managing bandwidth allocations from a node of a network transporting digital packets using IP protocol, the apparatus being characterized in that it includes means for receiving bandwidth or bit rate requests from terminals, and means for allocating or refusing requested bandwidths as a function of overall bandwidth availability.

In an example, this apparatus has means for collecting bandwidth requests and for establishing statistics on the basis of said requests in order to make forecasts concerning future requests and for taking account of these forecasts in allocating bandwidth to each terminal.

### BRIEF DESCRIPTION OF THE DRAWINGS

Other characteristics and advantages of the invention appear from the following description of various embodiments given with reference to the accompanying drawings, in which:

FIG. 1 is a diagram of a conventional telecommunications network;

FIGS. 2 and 3 are diagrams showing the known properties of the TCP protocol;

FIG. 2a is a diagram analogous to the diagram of FIG. 2 for the protocol of the invention;

FIG. 4 is a diagram showing a portion of equipment in a network in accordance with the invention; and

FIG. 5 is a more detailed diagram of certain portions of the network shown in FIG. 4.

### MORE DETAILED DESCRIPTION

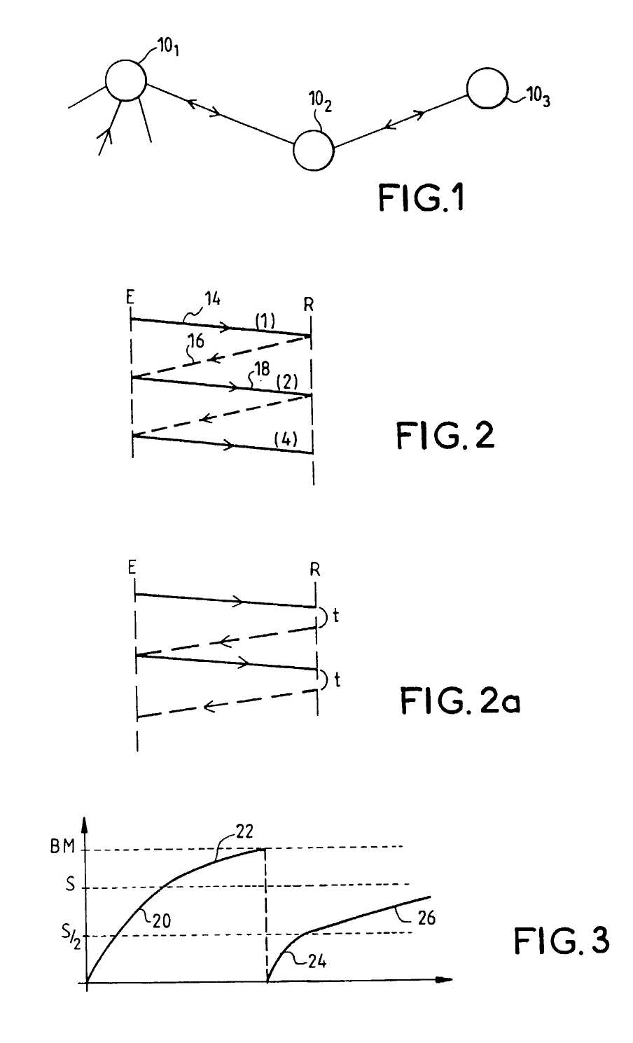

Firstly it is recalled that an Internet type communications network uses a variety of types of communications means. In general, the network comprises a backbone with nodes 10₁, 10₂, 10₃ etc. (FIG. 1) with communication taking place between them at a high bit rate using the ATM standard, i.e. a standard in which quality of service is imposed between the nodes. However, from each node to a terminal, it is generally not possible in simple manner to impose a quality of service when relying on the protocols that are used in the Internet, i.e. IP protocol for the network layer, the TCP or UDP transport protocol, and application protocols such as HTTP.

In the preferred embodiment of the invention, the TCP transport protocol is used between the network node and the terminal, and provision is made for the system to limit bandwidth usage to the requirements of the user by adjusting the acknowledgment duration in the TCP protocol.

To determine these requirements, the system analyzes received packets (in general the initial packet suffices for this analysis, which analysis is performed on content (e.g. video) and on content type (e.g. MPEG format)) in order to deduce the bit rate needed to enable the transported content to be played back properly, or in order to determine the maximum time delay between two successive packets, where the information can be constituted by the size of a file, display resolution, or the number of frames per second.

Before describing an embodiment of the invention in detail, the principle of the TCP protocol is recalled with reference to FIGS. 2 and 3.

When a receiver R has ordered data packets to be sent from a sender E, the sender E begins by sending a single packet: line 14. When the receiver R has received this packet, it immediately returns an acknowledge signal to the sender E which then sends two packets: line 18. After the acknowledge signal has been sent from the receiver to the sender, the sender E sends twice as many packets, i.e. four.

Thus, the number of packets sent is initially multiplied by 2 on each occasion until a predetermined threshold has been reached, e.g. 64. When this predetermined threshold has been reached, the number of packets sent during a transmission continues to be increased, but this is no longer done by increasing in geometric progression, but rather by increasing in arithmetic progression, each time the number of packets is increased by one unit until the maximum bandwidth is reached.

When this limit (maximum bandwidth) is reached, then the packet sending process is restarted, but the predetermined threshold value is set to half the previous value.

The way in which data rate varies as a function of time is thus represented by the diagram of FIG. 3 where it can be seen that a curve 20 begins by growing exponentially up to a threshold S, and beyond the threshold S it increases in linear manner 22. Once the maximum bandwidth BM is reached, the data rate drops to zero and then increases exponentially (curve 24) until it reaches the threshold S/2, after it which it rises linearly (26) until reaching the maximum bandwidth, and so on.

The diagram of FIG. 3 shows that when the invention is not used, TCP protocol suffers from two troublesome drawbacks: firstly the maximum bandwidth is occupied periodically, assuming there is no error, and this is to the detriment of other applications, and secondly this bandwidth is not used in optimum manner.

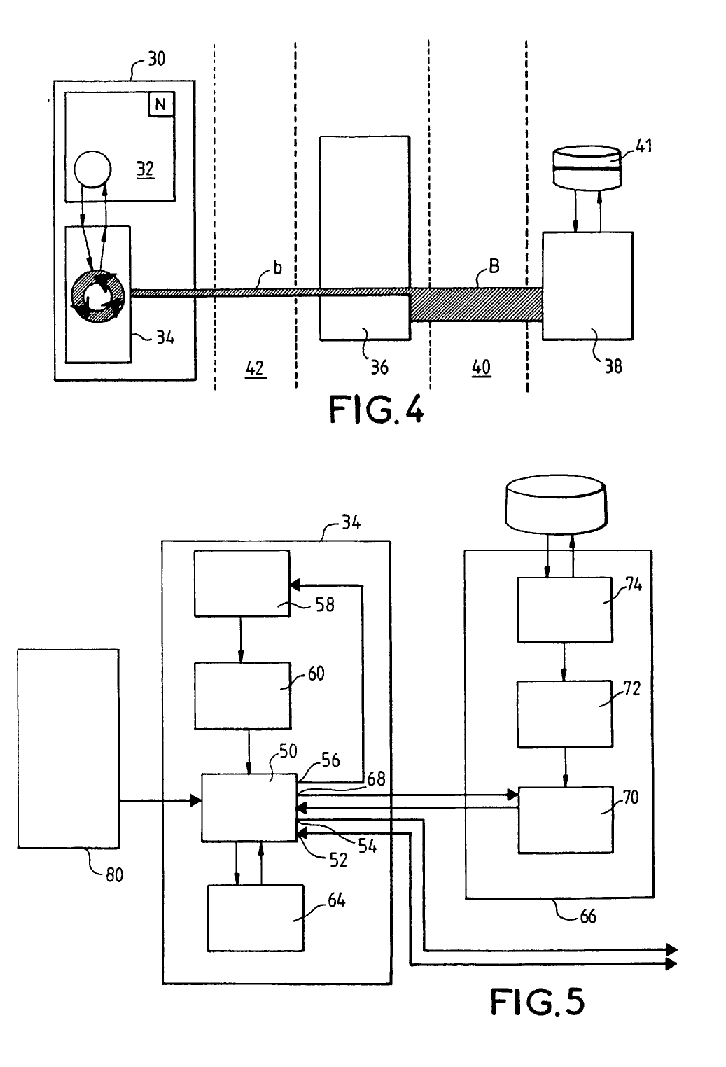

FIG. 4 shows a portion of the Internet used in accordance with an embodiment of the invention.

In this example, a client terminal 30 has an HTTP navigator 32 which is associated with a software analysis and regulation tool 34 enabling quality of service information for the client to be recovered, said tool 34 being shown in greater detail in FIG. 5 which is described below.

The tool 34 is connected to a node 36 and this node is itself connected to the Internet, in particular to a server 38.

Operation is described below with reference to an example in which the client terminal 30 is seeking to download video, e.g. in the MPEG1 standard. In this case, the navigator 32 triggers downloading by sending an HTTP request associated with a TCP connection. The remote server 38 sends the requested file which is to be found in its mass memory 40 constituted by a hard disk (a magnetic disk), a disk in DVD format, a disk in CD format, or any other storage means, and the file is transmitted over the Internet 40 to the node 36 and then from the node 36 over the private network 42 (i.e. a network in which each end is controlled or mastered) going to the terminal 30.

The headers of the MPEG1 packets contain information about the data rate needed to display the video without waiting, e.g. 2.51 megabits per second (Mbit/s). Thus, the tool 34 extracts this information from the first packets to be received, and on the basis of this information it sets a TCP acknowledgment time, i.e. the time t between receiving data and sending the acknowledge signal (FIG. 2a), and it does so in such a way that the bit rate does not exceed the necessary value, i.e. 2.51 Mbit/s.

In a variant, the UDP protocol is used in which no provision is made for an acknowledge signal. In which case, regulation is performed by controlling the spacing in time between successive incoming packets.

In another example, the file to be loaded or displayed is of the JPEG type. In this case, the tool 34 analyzes and regulates, recovering the size of each file from the headers of the initial packets and, in order to determine bit rates, it considers that downloading should be performed within a time of about 3 seconds.

Thus, in the Internet 40, the bandwidth used is B, and starting from node 36 the bandwidth is b (less than B), as shown in FIG. 4.

As shown in FIG. 5, the analysis and regulation software tool 34 which enables a particular quality of service to be ensured comprises an interceptor-distributor 50 which handles packets and is connected via an input 52 and an output 54 to the remote server 38 (FIG. 4). The role of this interceptor-distributor is to use an output 56 to send the first-received packets to an analyzer 58 which extracts useful information from the headers of these first-received packets so as to be able to compute the bandwidth needed, this useful information being constituted in particular by file size, number of frames per second, resolution, etc.

The data extracted from the initial packets is forwarded to a unit 60 for calculating the bandwidth necessary. The bandwidth determined by the unit 60 is forwarded to the interceptor-distributor unit 50 which can then adjust the acknowledgment duration t as a function of the bandwidth needed.

In addition, in this example, the tool 34 includes a bandwidth smoother 64 which puts limits on the bandwidth in order to comply with certain predetermined constraints, for example it calculates bit rate in real time and then adds or subtracts time in order to keep the bit rate at a constant value.

Furthermore, in this example, the interceptor-distributor 50 is connected to means 66 for managing bandwidth that are located in the node 36 (FIG. 4) having the role of authorizing or not authorizing bandwidth allocation as determined by the unit 60, possibly after being corrected by the smoother 64. In this embodiment, account is also taken of the needs of other users and each application 80 is allocated only the bandwidth needed for the request made. This bandwidth may be refused or reduced if other active applications are limiting the amount of bandwidth available to a value that is less than that needed by the application.

Thus, the interceptor-distributor 50 is connected via an inlet/outlet 68 to bandwidth allocation means 70 which determine the bandwidth to be allocated as a function of the data received from an analyzer 72 and from means 74 for collecting statistics.

These statistics-collecting means 74 collect a variety of user data, and in particular data that is local to the terminal and data that is global, covering various users connected to the node.

The analyzer 72 uses the data supplied by the collector 74 to determine whether the bandwidth requested by the user can be satisfied. It also collects earlier uses of bandwidth in order to forecast the bandwidth that might be requested by each application at any time.

Thus, the collector 74 collects bandwidth information from network equipment and bandwidth information from users via their equipment.

The analyzer 72 determines not only the bandwidth that is available, but it also makes forecasts of future availability as a function of the statistical data.

The bandwidth allocation means 70 may offer other solutions to a user, for example smaller bandwidth, in order to avoid running the risk of congesting the network. In a variant, a user might be asked to wait for some precomputed length of time before the user's request is satisfied.

1/ A method of receiving packets via a telecommunications network using IP protocol, the method being characterized in that at least the content (video) and the content type (MPEG1) of the first incoming packet is analyzed, the bandwidth and/or bit rate required is calculated (60) on the basis of the result of this analysis, and the reception bandwidth (b) or bit rate is adjusted (70) as a function of the result of the calculation.

2/ A method according to claim 1, characterized in that the requested bandwidth is allocated only if it does not exceed a predetermined limit.

3/ A method according to claim 1, characterized in that the bandwidth allocated is made to depend (72) on bandwidth requests coming from other users.

4/ A method according to claim 3, characterized in that the bandwidth allocated to a receiver is made to depend both on other users' usage or requests for bandwidth, and also on a forecast of the future bandwidth requests from said other users.

5/ A method according to claim 3, characterized in that bandwidth allocation is implemented from the network node to which the user is connected.

6/ A method according to claim 1, characterized in that for a user relying on TCP protocol, the bandwidth or bit rate is adjusted by setting the received packet acknowledgment duration (t).

7/ A method according to claim 1, characterized in that for a user relying on UDP protocol, the bandwidth or bit rate is adjusted by setting the time between reception of two successive packets.

8/ A telecommunications terminal (30) for receiving, on request, packets using the IP protocol via an Internet type network, the terminal being characterized in that it has means (34) for analyzing the content (video) and the content type (MPEG1) of at least the first-received packet in order to determine the bandwidth or the bit rate needed to receive the requested packets, and means for adapting the reception bandwidth or bit rate to the results provided by the analysis means.

9/ A terminal according to claim 8, characterized in that for a terminal relying on a protocol of the TCP type in which the receiver sends an acknowledgment of receipt to the sender after receiving a packet or a set of packets in order for the sender to continue sending, the means for adapting bandwidth or bit rate comprise means for varying the acknowledgment duration (t), i.e. the time that elapses between reception and sending an acknowledgment.

10/ A terminal according to claim 8, characterized in that for packets received using a protocol of the UDP type, without acknowledgment being sent to the sender, the means for regulating the bandwidth or bit rate comprise means for controlling the spacing between received packets.

11/ A terminal according to claim 8, characterized in that it includes means (64) for limiting the requested bandwidth.

12/ A terminal according to claim 8, characterized in that it includes means for receiving bandwidth authorization after said sending a request.

13/ Apparatus (66) for managing bandwidth allocations from a node of a network transporting digital packets using IP protocol, the apparatus being characterized in that it includes means (70) for receiving bandwidth or bit rate requests from terminals, and means for allocating or refusing requested bandwidths as a function of overall bandwidth availability.

14/ Apparatus according to claim 13, characterized in that it includes means for collecting bandwidth requests and for establishing statistics on the basis of said requests in order make forecasts of future requests and in order to take said forecasts into account when allocating bandwidth to each terminal.
